(19) United States
(12) Patent Application Publication
(10) Pub. No.: US 2012/0301107 A1
(43) Pub. Date: Nov. 29, 2012

(54) Recording and Reproducing Apparatus

(75) Inventor: Akira Takebe, Daito-shi (JP)

(73) Assignee: Funai Electric Co., Ltd.

(21) Appl. No.: 13/472,601

(22) Filed: May 16, 2012

(30) Foreign Application Priority Data
May 24, 2011 (JP) 2011-116151

(51) Int. Cl. H04N 9/80

(52) U.S. Cl. 386/241; 386/E09.011

(57) ABSTRACT

When a recording and reproducing apparatus additionally records a title in a BD, a title number of the recorded title is additionally stored in a management information file and also, order of storage of all the title numbers in the management information file to which the title number has been added is sorted based on attribute information included in title information in accordance with a sort type, and subsequently, the management information file is updated with the sorted data. Consequently, the order of storage of the title numbers in the management information file in the BD is changed in order of a user's intention and the titles are reproduced in accordance with the order of storage of the title numbers.

### BACKGROUND OF THE INVENTION

1. Field of the Invention

The present invention relates to a recording and reproducing apparatus which can record a title (video content).

2. Description of the Related Art

Conventionally, there is a recording and reproducing apparatus (recorder) which can record titles in an optical disk, which can additionally record data such as DVD-R, DVD-RW, BD-R, or BD-RE, so as to reproduce each title in accordance with order of storage of a title number in management information (file). When the title (video content) inputted from a tuner or the like is directly recorded in the optical disk, the above type of recording and reproducing apparatus assigns the title number in the management information of the optical disk in order of recording (storage) of the title (video content).

Japanese Laid-Open Patent Publication No. 2010-21965 discloses a video/audio edit assisting apparatus which efficiently creates a playlist (corresponding to a virtual playlist in BDAV (Blu-ray Disk Audio/Visual)) in the above type of recording and reproducing apparatus. According to this apparatus, video/audio materials, which are the basis of the playlist, can be sorted efficiently.

### BRIEF SUMMARY OF THE INVENTION

However, in the above conventional recording and reproducing apparatus which can assign the title number in the order of recording of the title and reproduce the title in accordance with the order of storage of the title number, the order of storage of the title number cannot be changed once the title number is assigned, so that a user cannot reproduce more than one title recorded in the optical disk in order of the user's intention (without using a virtual playlist described below).

In contrast, when a title recorded in a hard disk is copied to an optical disk in the above conventional recording and reproducing apparatus, each title which is to be copied can be rearranged and recorded in the optical disk in the order of the user's intention, so that the each title can be reproduced in the order of the user's intention. However, when a new title is additionally recorded in the optical disk which already records other titles, a title number of the added title in management information of the optical disk is stored after title numbers of other titles which are already recorded. Accordingly, even when a creation date and time of the title which is additionally recorded (a date and time when the title is recorded in the hard disk) is earlier than that of any other title which is already recorded in the optical disk, the title number of the added title is recorded as a last title number in the management information of the optical disk, so that the added (the earliest) title is reproduced last.

Some BD (Blu-ray Disk) recorder has a function of creating a virtual playlist. It is efficient for the optical disk in which all the titles are fixed (all the titles are already recorded) to create the virtual playlist, however, when a new title is additionally recorded after creating the virtual playlist, the added title is not included in the virtual playlist which is already created, so that an operation to register the added title in the virtual playlist (change the virtual playlist) is required. Moreover, when the title included in the virtual playlist is deleted after creating the virtual playlist, the title referenced by the virtual playlist is lost, so that the virtual playlist itself can be deleted. In the above case, an operation to recreate the virtual playlist is required. Furthermore, it is essentially complicated to create the virtual playlist.

Moreover, even if the video/audio edit assisting apparatus described in the above Japanese Laid-Open Patent Publication No. 2010-21965 is used, the operation performed by the user to select the video/audio materials and then create the playlist cannot omitted, so that the user's trouble cannot be significantly reduced.

The present invention is to solve the problem described above, and an object of the present invention is to provide a recording and reproducing apparatus which can create a recording medium, which can reproduce more than one title recorded in the recording medium in order of a user's intention, with a simple operation. Moreover, an object of the present invention is to provide a recording and reproducing apparatus which can automatically create a recording medium which can reproduce all titles including an additionally-recorded title in order of a user's intention when recording the title additionally in the recording medium.

According to an aspect of the present invention, this object is achieved by a recording and reproducing apparatus which can record a title in a recording medium, which has application format of separately recording a management information file which stores a title number for each recorded title and title information file which stores title information including attribute information for each recorded title, so that each title can be reproduced in accordance with order of storage of the title number in the management information file.

The above recording and reproducing apparatus comprises: a sort type setting means which sets a sort type of the title number in the management information file; a sort means which sorts the order of storage of the title number in the management information file based on the attribute information included in the title information stored in the title information file in accordance with the sort type set by the sort type setting means; and a management information file update means which updates the management information file with data in which the order of storage of the title number is sorted by the sort means.

In the above configuration, with only a simple operation of setting the sort type of the title number in the management information file by the sort type setting means, the order of storage of the title number in the management information file is sorted based on the attribute information included in the title information stored in the title information file in accordance with the set sort type, and the management information file is updated with data in which the order of storage of the title number is sorted. Consequently, the order of storage of the title number in the management information file in the recording medium is changed in accordance with the user's intention and the titles are reproduced in accordance with the order of storage of the title numbers, so that the recording medium which enables the reproduction of more than one recorded title in the order of the user's intention can be created with the simple operation.

It is preferable that the above recording and reproducing apparatus further comprises: a sort type memory means which stores the sort type set by the sort type setting means; and an additional recording control means which, when the title is additionally recorded in the recording medium, additionally stores the title number of the recorded title in the management information file, and also sorts the order of storage of all the title numbers in the management information file, to which the title number has been added, based on the attribute information included in the title information which is stored in the title information file in accordance with the sort type stored in the sort type memory means, and subsequently updates the management information file by the management information file update means with the data in which the order of storage of all the title numbers is sorted.

In the above configuration, when the title is additionally recorded in the recording medium, the title number of the recorded title is additionally stored in the management information file and also, the order of storage of all the title numbers in the management information file, to which the title number has been added, is sorted based on the attribute information included in the title information which is stored in the title information file in accordance with the sort type stored in the sort type memory means, and subsequently, the management information file is updated with the data in which the order of storage of all the title numbers is sorted. Consequently, the recording medium which enables the reproduction of all the titles including the additionally-recorded title in the order of the user's intention can automatically be created when the title is additionally recorded in the recording medium.

An application format of the above recording medium may also be BDAV (Blu-ray Disk Audio/Visual). According to the above configuration, the above effect can certainly be obtained in the recording and reproducing apparatus which can record and reproduce the title in the recording medium having the BDAV application format.

### BRIEF DESCRIPTION OF THE DRAWINGS

The present invention will be described below with reference to the annexed drawings. It is to be noted that all the drawings are shown for the purpose of illustrating the technical concept of the present invention or embodiments thereof, wherein:

FIG. 1 is an electrical block diagram of a BD recorder, which is a recording and reproducing apparatus according to a preferred embodiment of the present invention;

FIG. 2 is a diagram showing a configuration of data stored in a BD having a BDAV application format;

FIG. 3 is a flow chart of a title addition processing in the BD recorder in FIG. 1;

FIG. 4 is a diagram showing a sort type selection menu in the BD recorder in FIG. 1; and

FIG. 5 is a flow chart of a title sorting processing in the BD recorder in FIG. 1.

### DETAILED DESCRIPTION OF THE INVENTION

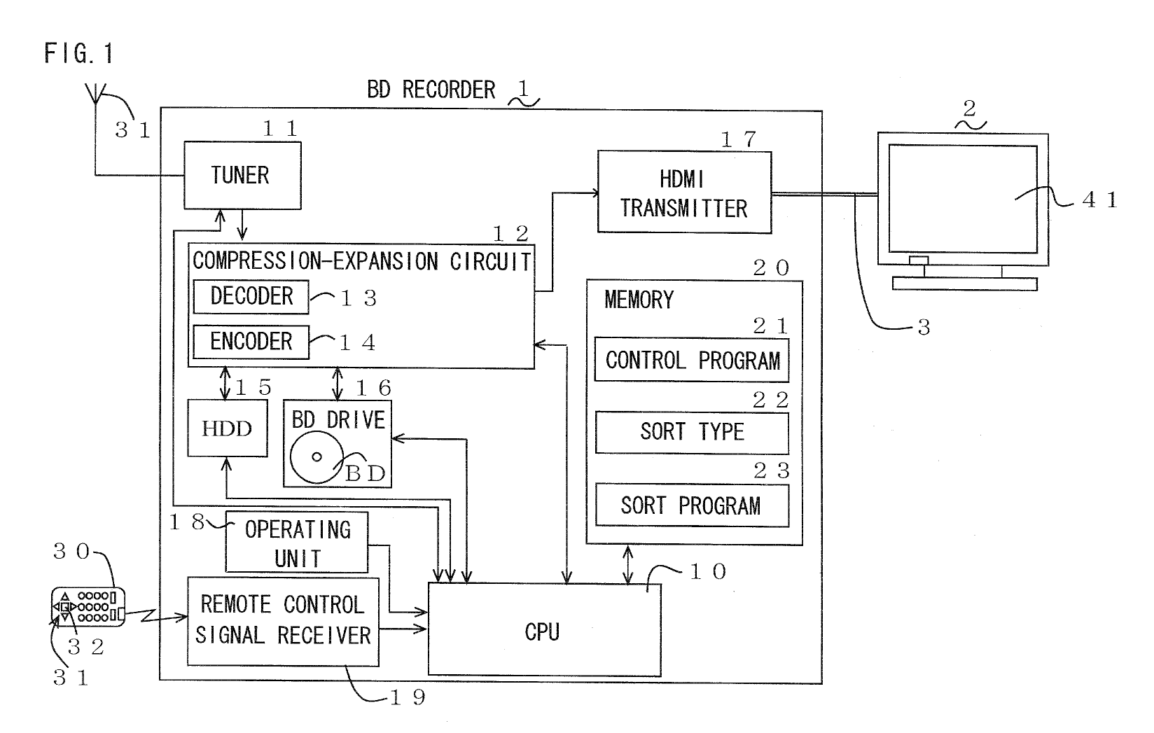

A recording and reproducing apparatus according to a preferred embodiment of the present invention is described with reference to FIGS. 1 to 5. In the preferred embodiment described below, an example of applying the present invention to a BD (Blu-ray Disk) recorder provided with a HDD (Hard Disk Drive) is described. The preferred embodiment of the present invention described below is not intended to be exhaustive or to limit the invention to the following configuration.

FIG. 1 shows a BD recorder 1 provided with a HDD (abbreviated as the BD recorder 1 hereinafter), which is the recording and reproducing apparatus according to the present preferred embodiment. The BD recorder 1 is connected to a television receiver 2 (abbreviated as the TV receiver 2 hereinafter) via a HDMI cable 3. The BD recorder 1 comprises a CPU 10 (additional recording control means) which controls the whole apparatus, a tuner 11 which receives digital television broadcast signals (transport stream) via an antenna 31, a compression-expansion circuit 12 which includes a decoder 13 and an encoder 14.

The above decoder 13 decodes a packet in the transport stream received by the tuner 11, decodes a title (video content) of a digital television broadcast program (file), which is recorded, in a compression format, in not only a hard disk (in a HDD 15) but also a BD (recording medium in claims) set in a BD drive 16, or the like, and reproduces video signals or audio signals. The above encoder 14 compresses the video signals and the audio signals, which is reproduced by the decoder 13, by a compression method and at a compression rate to suit the hard disk or the BD, and transmits them to the HDD 15 or the BD drive 16. Moreover, the encoder 14 compresses a title (video content) of a program (file) recorded in the hard disk by a compression method and at a compression rate to suit the BD and transmits them to the BD drive 16 at a time of copy processing.

The BD recorder 1 further includes the HDD 15, which records the title of the program (file) compressed by the above encoder 14 in the built-in hard disk and reads out the title recorded in the hard disk, and the BD drive 16 (management information file update means) which records the title, which is compressed by the encoder 14 at a compression rate different from that applied to record the title in the hard disk, in the BD and reads out the title recorded in the BD. Moreover, the BD recorder 1 includes a HDMI transmitter 17. The HDMI transmitter 17 transmits the decoded video signals and audio signals transmitted from the decoder 13 to the TV receiver 2 via the HDMI cable 3.

Furthermore, the BD recorder 1 comprises an operating unit 18 which has plural operation keys on a panel in a body of the apparatus, a remote control signal receiver 19 which receives infrared remote control signals from a remote controller 30, a memory 20 (sort type memory means) which stores a program used for various processing executed by the CPU 10 or various data, and the remote controller 30 which has the plural command operation keys. An arrow key 31, which is user for selecting items in various menus, and an enter key 32 are provided on the remote controller 30.

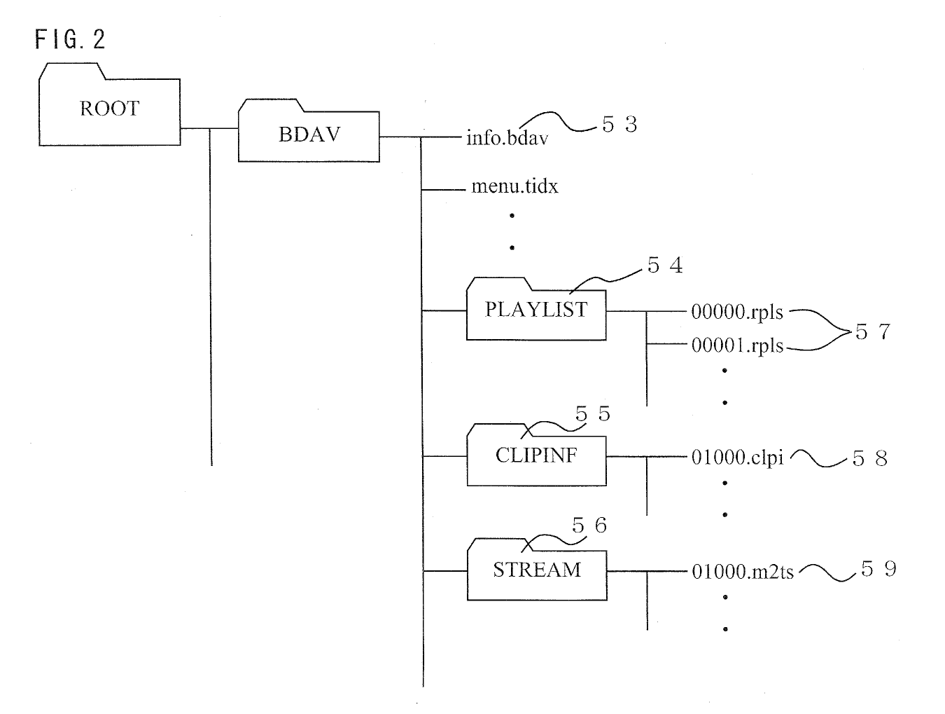

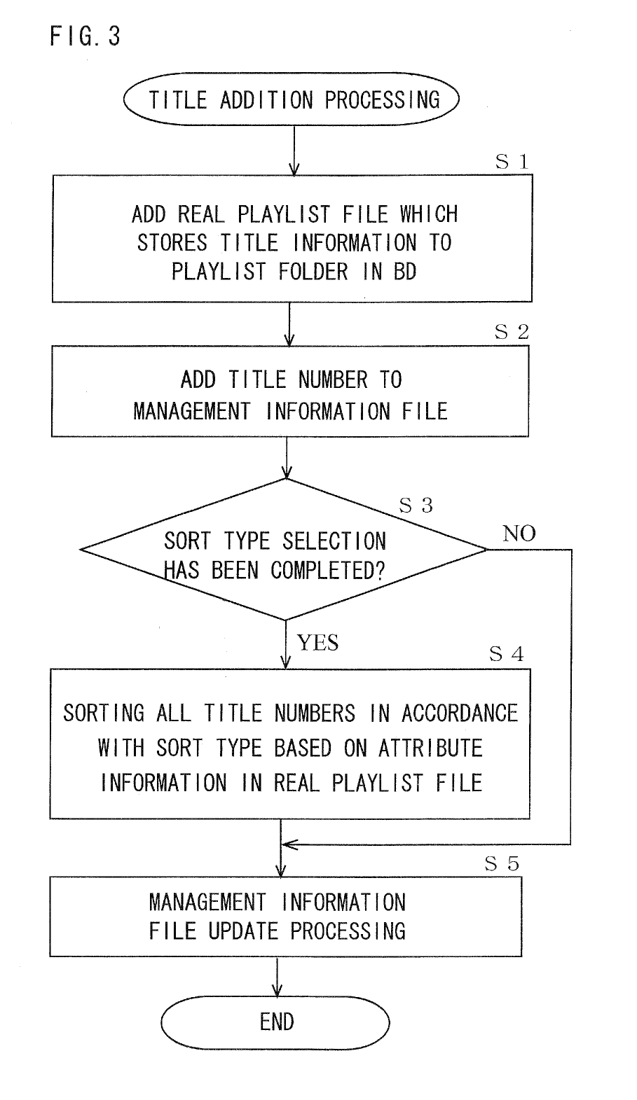

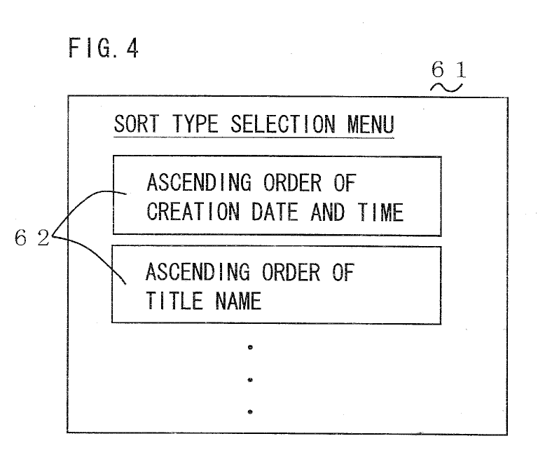

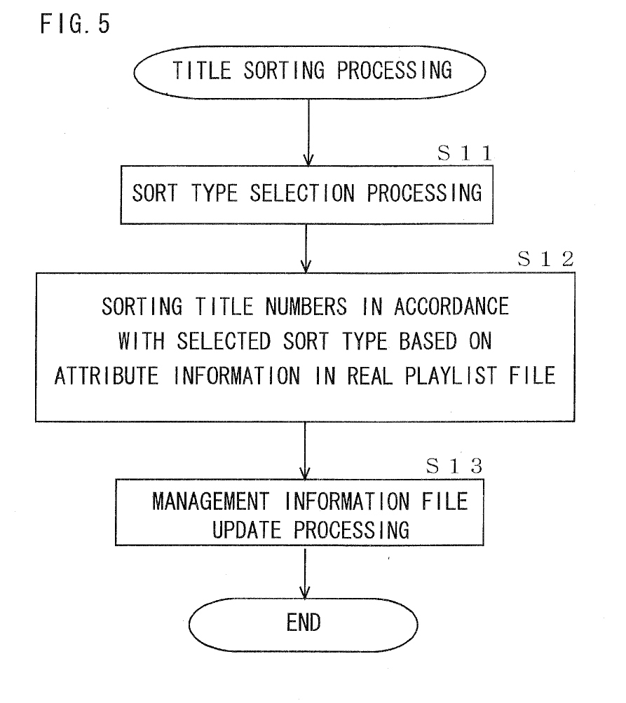

The program and the data stored in the above memory 20 includes a control program 21 which is a program for controlling the whole apparatus in processing such as a title addition processing (refer to FIG. 3) or a title sorting processing (refer to FIG. 5) described below, a sort type 22 which is selected (set) in a sort type selection menu 61 (refer to FIG. 4) described below, and a sort program 23 which sorts the title numbers in an info.bdav 53 (the management information file in claims) in FIG. 2 based on attribute information of a creation date and time or the like, which is included in title information stored in a real playlist file 57 (a title information file in claims) shown in FIG. 2, in accordance with the sort type 22. The sort program 23 and the above CPU 10 correspond to a sort means in claims. Moreover, the CPU 10 and the remote controller 30 mainly correspond to a sort type setting means in claims.

The above BD such as BD-R or BD-RE which can additionally record data records the title in BDAV (Blu-ray Disk Audio/Visual) format, which is the application format for BD-R or BD-RE.

FIG. 2 shows a configuration of data stored in the BD (BD-R, BD-RE) having the BDAV application format. In the BD having the BDAV application format, as shown in FIG. 2, the info.bdav 53 (management information file) which stores the title number for each title, the real playlist file 57 (title information file) which stores the title information including the attribute information such as the creation date and time for each title, a name for each title, or the like, a stream file 59 which collects video/audio data of each title, and a clip information file 58 which manages information relating to a stream of each title are separately recorded (in separate folders). In the case where the virtual playlist has not been created yet, the BD recorder 1 reproduces the plural titles stored in the BD (BD-R, BD-RE) in accordance with the order of storage of the title numbers in the info.bdav 53.

Next, in addition to a flow chart in FIG. 3, a processing of additionally recording the title in the BD (title addition processing) in the BD recorder 1 is described with reference to the above FIG. 2 and FIG. 4. The processing described below is executed by the CPU 10 based on the control program 21 stored in the memory 20. When the user sends a command to additionally record the title of the television program or the like in the BD using the remote controller 30 (both cases of directly recording the title received by the tuner 11 in the BD via the compression-expansion circuit 12 and copying the title recorded in the hard disk to the BD are included), the CPU 10 additionally stores the real playlist file 57, which stores the title information for the added title, in a playlist folder 54 shown in FIG. 2 (S1) and additionally stores the title number for the added title in the info.bdav 53 (management information file) (S2).

Next, the CPU 10 determines whether or not a sort type selection (setting) processing using the sort type selection menu 61 shown in FIG. 4 has been completed (S3). In particular, the CPU 10 determines whether or not the sort type selection (setting) processing has been completed by determining whether the (effective) sort type 22 is stored in the memory 20. As a result, when the sort type selection processing has already been completed (the effective sort type 22 is stored in the memory 20) (YES in S3), the CPU 10 sorts the order of storage of all the title numbers in the info.bdav 53, to which the title number has been added, by the sort program 23 based on the attribute information included in the title information in each real playlist file 57 (corresponding to the title) in the playlist folder 54 shown in FIG. 2, in accordance with the sort type 22 stored in the memory 20 (S4). Subsequently, the CPU 10 updates the info.bdav 53 with the sorted data by the BD drive 16 (S5).

The sorting processing in the above S4 is described in detail. When the user uses the remote controller 30 and selects “ascending order of creation date and time”, for example, as a sort type 62 in the sort type selection processing using the sort type selection menu 61 shown in FIG. 4, data indicating “ascending order of creation date and time” (a classification code or the like) is stored in the memory 20 as the sort type 22.

In the above case (when “creation date and time in ascending order” is selected), in the above S4, the CPU 10 reads in the information of the creation date and time included in the real playlist file 57, which corresponds to each title, in the playlist folder 54 shown in FIG. 2, by the BD drive 16. And then, the CPU 10 sorts the order of storage of all the title numbers in the info.bdav 53, to which the title number has been added, in ascending order of the creation date and time based on the information of the creation date and time of each title. Accordingly, different from the conventional art, when the title is additionally copied to the BD, in the case where the creation date and time of the added title (the date and time when the title was recorded in the hard disk) is earlier than that of any other title which has already been recorded in the BD, the added (the earliest) title can be reproduced first.

That is to say, once the user performs in advance the processing of selecting “ascending order of creation date and time” as the sort type 62 using the sort type selection menu 61 shown in FIG. 4 and the remote controller 30, the BD which enables the reproduction of the titles in ascending order of the creation date and time of the titles can automatically be created when the title is additionally recorded in the BD.

When the virtual playlist has not been created, the BD recorder normally reproduces the titles stored in the BD (BD-R, BD-RE) in accordance with the order of storage of the title numbers in the info.bdav 53. Accordingly, as described above, by sorting the order of storage of the title numbers in the info.bdav 53 in ascending order of the creation date and time of the titles, the BD which enables the reproduction of the titles in ascending order of the creation date and time can automatically be created.

Moreover, once the user performs in advance the processing of selecting “ascending order of title name” as the sort type 62 using the sort type selection menu 61 shown in FIG. 4 and the remote controller 30, the order of storage of the title numbers in the info.bdav 53 can be sorted in ascending order of the title name when the title is additionally recorded in the BD, so that the BD which enables the reproduction of the titles in ascending order of the title name can automatically be created.

According to the present BD recorder 1, when the user directs the BD recorder 1 to sort the order of storage of the title numbers in the info.bdav 53 at an arbitrary timing, the order of reproduction of the titles recorded in the BD can be changed in accordance with the user's intention without creating the virtual playlist.

FIG. 5 is a flow chart showing a sorting processing of the title number (title sorting processing) executed at the above arbitrary timing When the user wants to change the order of reproduction of the titles recorded in the BD, the user firstly directs the BD recorder 1 to display the sort type selection menu 61 shown in FIG. 4 on the display 41 of the TV receiver 2 using the remote controller 30 and subsequently selects the desired sort type 62 from the plural sort types 62 displayed on the sort type selection menu 61 using the remote controller 30 (S11). When the selection processing has been completed, the CPU 10 stores the sort type 22 in the memory 20, subsequently sorts the order of storage of all the title numbers in the info.bdav 53 of the BD based on the attribute information in each real playlist file 57 (corresponding to each title) in accordance with the sort type 22 stored in the memory 20 by the sort program 23 in the same manner as the above S4 (S12). Subsequently, the CPU 10 updates the info.bdav 53 with the sorted data by the BD drive 16 (S13).

As described above, according to the BD recorder 1 of the present preferred embodiment, with only a simple operation performed by the user to set the sort type of the title numbers in the info.bdav 53 by using the sort type selection menu 61 and the remote controller 30, the order of storage of the title numbers in the info.bdav 53 is sorted based on the attribute information included in the title information stored in the real playlist file 57 in accordance with the set sort type, and then the info.bdav 53 is updated with the sorted data. Consequently, the order of storage of the title numbers in the info.bdav 53 of the BD is changed in accordance with the user's intention, and the titles are reproduced in accordance with the changed order of storage of the title numbers. Thus the BD (BD-R, BD-RE) which enables the reproduction of more than one recorded title in the order of the user's intention can be created with the simple operation.

Moreover, according to the present BD recorder 1, when the title is additionally recorded in the BD, the title number of the recorded title is additionally stored to the info.bdav 53 and also, the order of storage of all the title numbers in the info.bdav 53, to which the title number has been added, is sorted based on the attribute information included in the title information which is stored in the info.bdav 53 in accordance with the sort type 22 stored in the memory 20. Subsequently, the info.bdav 53 is updated with the sorted data. Consequently, the BD (BD-R, BD-RE) which enables the reproduction of all the titles including the additionally-recorded title in the order of the user's intention can automatically be created when the title is additionally recorded in the BD.

The present invention is not limited to the configuration of the above preferred embodiment, however, various modification are applicable within the scope of the invention. For example, in the above preferred embodiment, the present invention is applied to the BD recorder provided with the HDD, however, the present invention may also be applied to a BD recorder which is not provided with the HDD or a recording and reproducing apparatus such as iPod (registered trademark) in which a semiconductor memory is used. Moreover, in the above preferred embodiment, the display of the TV receiver connected to the BD recorder displays the sort type selection menu, however, a display on the BD recorder side may display the sort type selection menu.

This application is based on Japanese patent application No. 2011-116151 filed on May 24, 2011, the contents of which are hereby incorporated by reference.

1. A recording and reproducing apparatus which can record a title in a recording medium, which has application format of separately recording a management information file which stores a title number for each recorded title and a title information file which stores title information including attribute information for each recorded title, so that each title can be reproduced in accordance with order of storage of the title number in the management information file, the recording and reproducing apparatus, comprising:
a sort type setting means which sets a sort type of the title number in the management information file;
a sort means which sorts the order of storage of the title number in the management information file based on the attribute information included in the title information stored in the title information file in accordance with the sort type set by the sort type setting means; and
a management information file update means which updates the management information file with data in which the order of storage of the title number is sorted by the sort means.

2. The recording and reproducing apparatus according to claim 1, further comprising:
a sort type memory means which stores the sort type set by the sort type setting means; and
an additional recording control means which, when the title is additionally recorded in the recording medium, additionally stores the title number of the recorded title in the management information file and also sorts the order of storage of all the title numbers in the management information file, to which the title number has been added, based on the attribute information included in the title information which is stored in the title information file in accordance with the sort type stored in the sort type memory means, and subsequently updates the management information file by the management information file update means with the data in which the order of storage of all the title numbers is sorted.

3. The recording and reproducing apparatus according to claim 2,
wherein an application format of the recording medium is BDAV (Blu-ray Disk Audio/Visual).

4. The recording and reproducing apparatus according to claim 1,
wherein an application format of the recording medium is BDAV (Blu-ray Disk Audio/Visual).
